(19) United States
(12) Patent Application Publication
(10) Pub. No.: US 2021/0147214 A1
(43) Pub. Date: May 20, 2021

(54) METHOD FOR HEATING A FUEL FILTER OF A FUEL DISPENSER

(71) Applicant: Neste Oyj, Espoo (FI)

(72) Inventors: Seppo MIKKONEN, Porvoo (FI); Jari SORVARI, Porvoo (FI)

(73) Assignee: Neste Oyj, Espoo (FI)

(21) Appl. No.: 16/613,992

(22) PCT Filed: Jun. 1, 2018
(86) PCT No.: PCT/FI2018/050415

§ 371 Date: Nov. 15, 2019

(30) Foreign Application Priority Data
Jun. 2, 2017 (FI) 20175500

(51) Int. Cl. B67D 7/04; B01D 35/18

(52) U.S. Cl. CPC B67D 7/04; B01D 35/30; B01D 35/18

(57) ABSTRACT

A fuel dispensing device can include a housing, a fuel supply pipe for fuel inlet, a fuel dispensing pipe for dispensing fuel, a fuel pump for pumping fuel from the fuel supply pipe to the fuel dispensing pipe, a fuel filter for filtering fuel to be dispensed, a metering unit between the fuel supply pipe and the fuel dispensing pipe and a control for controlling a function of the fuel dispensing device, wherein heating is provided for heating at least the fuel filter. A method for controlling this fuel dispensing device is also disclosed, wherein at least the fuel filter is heated when outside temperature is near or below fuel freezing point

### FIELD OF THE INVENTION

The invention relates to a method for controlling a fuel dispensing device comprising a housing, a fuel supply pipe for fuel inlet, a fuel dispensing pipe for dispensing fuel, a fuel pump for pumping fuel from the fuel supply pipe to the fuel dispensing pipe, at least one filter for filtering fuel to be dispensed, metering unit between the fuel supply pipe and the fuel dispensing pipe, and control means for controlling the function of the fuel dispensing device, wherein at least the fuel filter is heated when outside temperature is near or below fuel or water freezing point.

### BACKGROUND OF THE INVENTION

Blocking of filters of diesel fuel dispensing devices is a phenomenal happening every year especially in Nordic countries although this fuel in principal usually is good winter quality having respective cloud point. This blocking slows down refuelling of vehicles thereby causing client dissatisfaction. At the worst, refuelling may be totally hindered and a break in sale may happen. Next time the client maybe will be a client of a competing service or fuel station. During a sale break a serviceman must be sent to the service or (automatic) fuel station that along with the loss of sale causes work and travel expenses.

There are many reasons for the above disclosed blocking. During lowering of the temperature ice crystal will form in fuel, additives and heavy paraffins will dissolve in fuel etc. Even good quality fuel according to EN 590 standard will not always guarantee reliability.

It is known from the publication CN 101508413 that fuel may be warmed before it enters to the filter but this requires a lot of warming energy due to the huge volume of the flow in the dispensing device.

The publication U.S. Pat. No. 2,411,749 discloses that a part (a water trap) of a fuel dispensing device may be warmed but in this document the warming does not depend on the use of the pump.

### BRIEF DESCRIPTION [DISCLOSURE] OF THE INVENTION

An object of the present invention is thus to provide a fuel dispensing method for controlling a fuel dispensing device so as to solve the above problems. The object of the invention is achieved by a fuel dispensing method which is characterized in that the heating is performed periodically between the refuellings, wherein the fuel pump is not pumping fuel during said heating. The preferred embodiments of the invention are disclosed in the dependent claims.

In the present invention the filter is warmed by electricity, preferably when the fuel dispensing device is not pumping fuel. This reduces the need for both warming energy and a power supply to the fuel dispensing device.

An existing fuse and power supply of the dispensing device is enough for the warming because the pumping and the warming are not done at the same time. The warming of the filter requires less energy and a further energy saving is achieved because the warming of the filter during the pumping is unefficient.

### BRIEF DESCRIPTION OF THE DRAWINGS

In the following the invention will be described in greater detail by means of preferred embodiments with reference to the attached drawings, in which

FIG. 1 shows a cross sectional view of a preferred fuel dispensing device according to the invention; and

FIG. 2 shows a cross sectional view of another preferred fuel dispensing device according to the invention.

### DETAILED DESCRIPTION OF THE INVENTION

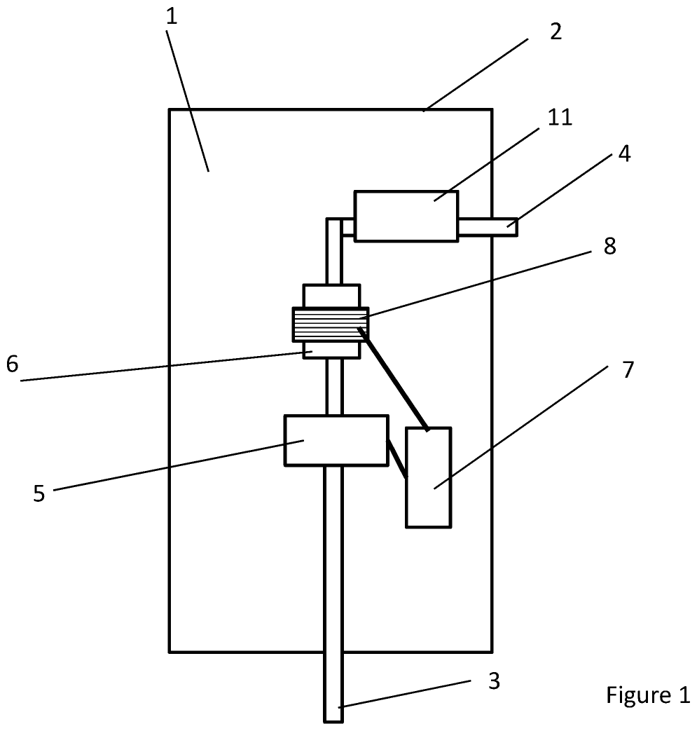

Referring to FIG. 1 the fuel dispensing device 1 comprises a housing 2, a fuel supply pipe 3 for fuel inlet, a fuel dispensing pipe 4 for dispensing fuel, a fuel pump 5 for pumping fuel from the fuel supply pipe 3 to the fuel dispensing pipe 4, a fuel filter 6 for filtering fuel to be dispensed, metering unit 11 between the fuel supply pipe 3 and the fuel dispensing pipe 4, and control means 7 for controlling the function of the fuel dispensing device 1.

In the embodiment of FIG. 1 an electrical heating cable 8 is arranged at least around the fuel filter 6.

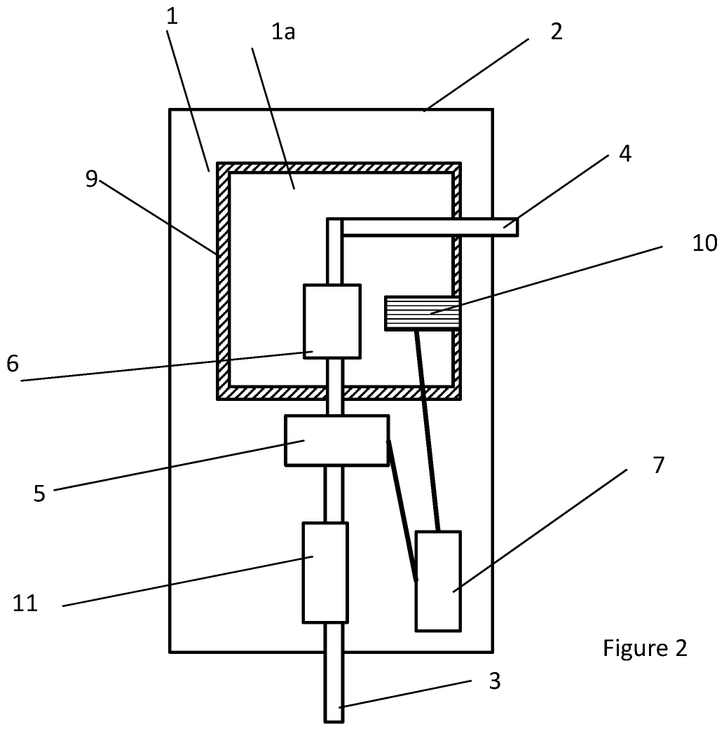

In the embodiment of FIG. 2 an insulating 9 is arranged inside a housing department 1a containing at least the fuel filter 6 and a heating 10 is arranged for heating this department 1a.

The control means 7 are arranged also to control the above disclosed heating, depending on the grade of fuel. In one embodiment the control means 7 controls that heating is on when the fuel pump 5 does not operate.

In one embodiment the fuel pump 5 is integrated to the fuel filter 6.

In one embodiment the fuel pump 5 is between the fuel filter 6 and the fuel dispensing pipe 4.

In one embodiment the fuel dispensing device 1 comprises more than one fuel filter 6. In one embodiment the fuel dispensing device 1 comprises three fuel filters 6 which all comprise an electrical heating cable 8.

All commonly known equipment relating safety, operating and paying may be combined to the fuel dispensing device 1 according to this invention.

Fuel which needs the warming is almost always diesel. There are different diesel fuel grades which have different freezing points. Warming could start when ambient temperature is near or below cloud point of diesel fuel sold during winter period. Warming could already start at near 0° C. or below if there is risk for ice crystal formation in the fuel. Warming could start some 10° C. above fuel's cloud point if fuel contains ester type biodiesel (FAME) as a blending component. For example in Finland this could mean that. These figures are valid for summer and winter quality fuels sold in Finland. In other countries the situation may be different depending on the climate. If fuel to be dispensed is summer quality diesel fuel, the warming could start when ambient temperature is near or below 0° C. When fuel is winter quality diesel fuel, warming could start when ambient temperature is near or below −27° C. Starting point for middle quality diesel fuel could be near or below −13° C. The heating temperature in each case could be around 20° C. above these ambient temperatures. Heating could be adjusted according to climate and fuel to avoid the disturbances caused by ice crystals in the fuel.

The warming of the filter 6 between the refuellings will succeed with a quite small amount of heat energy. For example, if there would a break of 20 minutes between the refuellings, a resistor of 60 W with a 50% efficiency would warm 1 litre of diesel fuel about 20° C. This will assist opening of the filter. For example, if 1 gram of ice crystals has been formed in the filter 6, it would rapidly melt with a heat energy of a few tens of watts.

When the filter 6 is warmed frequently enough between the refuellings, it will stay clean and the refuellings will take place without any disturbances. During vehicle filling there is coming cold fuel from tank and blocking the filter again causing disturbances in filling. In the night time there is more time for even longer periods of heating. The vehicles will receive good quality fuel, on average the same fuel which is contained in the containers of the fuel station. The aim is not to heat all fuel but to ensure that every refuelling would start with an easily permeable, cleaned filter 6.

Melted or dissolved components of course will enter to the fuel tank of following customer but the amount of these components will be negligible when the heating will happen frequently enough. The amount of impurities collected in the filter is quite small, but easily blocking due to high flow rates of fuel. A fuel filter of a vehicle will process the same amount of fuel considerably slower (in a car hours, in a fuel pump few minutes), the cross sectional area of the fuel filter of the car is considerably larger and the fuel filter of a car will heat during drive caused by heat of the motor, or the filter is heated separately. Flow rates through the filters in the fuel pumps typically are 50 l/min in the passenger cars and truck fuel dispensers have flow rate of 100-120 l/min.

The above description of the invention is only intended to illustrate the basic idea according the invention. A person skilled in the art may thus realize the invention and its details within the scope of the accompanying claims.

1. A method for controlling a fuel dispensing device having a housing, a fuel supply pipe for fuel inlet, a fuel dispensing pipe for dispensing fuel, a fuel pump for pumping fuel from the fuel supply pipe to the fuel dispensing pipe, at least one filter for filtering fuel to be dispensed, a metering unit between the fuel supply pipe and the fuel dispensing pipe, and a controller for controlling a function of the fuel dispensing device, the method comprising:
heating at least the fuel filter when an outside temperature is near or below a fuel or water freezing point, the heating being performed periodically between refuellings; and
controlling the fuel pump to not pump fuel during said heating.

2. A method as claimed in claim 1, comprising:
performing the heating by an electrical heating cable arranged at least around the fuel filter.

3. A method as claimed in claim 1, comprising:
performing the heating with an insulator arranged inside a housing department containing at least the fuel filter and for heating said housing department.

4. A method as claimed in claim 1, comprising:
controlling the heating by the controller.

5. A method as claimed in claim 1, wherein the fuel filter is a diesel fuel filter.

6. A method as claimed in claim 2, comprising:
controlling the heating by the controller.

7. A method as claimed in claim 3, comprising:
controlling the heating by the controller.

8. A method as claimed in claim 6, wherein the fuel filter is a diesel fuel filter.

9. A method as claimed in claim 7, wherein the fuel filter is a diesel fuel filter.
